(19) United States
(12) Patent Application Publication
(10) Pub. No.: US 2026/0195532 A1
(43) Pub. Date: Jul. 9, 2026

(54) SYSTEMS AND METHODS FOR CORPUS-BASED VERIFICATION OF AI-GENERATED CONTENT

(71) Applicant: Drexel University, Philadelphia, PA (US)

(72) Inventors: David Gefen, Yardley, PA (US); Shahin Jabbari, Philadelphia, PA (US); Rezvaneh Rezapour, Philadelphia, PA (US); Hildegarde Van den Bulck, New York, NY (US)

(73) Assignee: Drexel University, Philadelphia, PA (US)

(21) Appl. No.: 19/443,747

(22) Filed: Jan. 8, 2026

Related U.S. Application Data
(60) Provisional application No. 63/743,106, filed on Jan. 8, 2025.

(51) Int. Cl. G06F 40/279; G06F 40/40

(52) U.S. Cl. CPC G06F 40/279; G06F 40/40

(57) ABSTRACT

Computer-implemented systems and methods dynamically verify the trustworthiness of artificial-intelligence-generated content. A computing system receives a document generated by a large language model and extracts a reduced set of terms representing key truth-related arguments using statistical or language-model-based techniques. The reduced set is compared to corpus-derived terms obtained from related documents to identify matched, omitted, and additional arguments. Quantitative explainability metrics are computed based on relationships among the terms within the corpus, and a multidimensional trust representation is generated from the metrics. The trust representation may be stored as a structured data object and used to control subsequent content generation, filtering, or presentation by the computing system.

### BACKGROUND

The growing reliance on AI agents, such as LLM systems, to provide information and assessments raises concerns about the creation and circulation of biased, divisive, and harmful content, and thus the potential for extensive exposure to undeclared agendas and even subversion. That is not a new phenomenon, as accidental or strategic miscommunication for purposes of framing or for outright propaganda has a long history. In the pre-LLM World, people tended to know who prepared the information and where it came from, allowing them to judge the trustworthiness of any report. The ongoing processes of digitization, however, have resulted in a disconnect between the production and dissemination of information, probably most clearly in the case of content created and disseminated through LLMs, which undermines people's ability to evaluate content's trustworthiness. This opens a floodgate to untrustworthy, untruthful, even subversive, content and activities. According to the FBI and CISA, this is a real current threat and contributes to what philosophy and communication theories see as a growing epistemic crisis that extends beyond information to knowledge, because it affects (trust in) what we know, how we know it, and how we act based on that knowledge.

### SUMMARY OF THE EMBODIMENTS

The systems and methods described herein provide a computer-implemented technique for dynamically verifying the trustworthiness of content generated by artificial intelligence systems. A computing system processes a generated document to extract a reduced set of principal terms representing key truth-related arguments using statistical and language-model-based analyses. The system and method compares corpus-derived terms from related documents. Quantitative metrics characterizing relationships among the terms within the corpus are then computed and aggregated to produce a multidimensional trust representation. The disclosed techniques improve computer-based verification of AI-generated content without requiring retraining of underlying language models.

### BRIEF DESCRIPTION OF THE DRAWINGS

FIG. 1 is a graphic depiction of certain elements in Step 1.

FIG. 2 is a graphic depiction of certain elements in Step 1a.

FIG. 3 is a graphic depiction of certain elements in Step 2.

FIG. 4 is a graphic depiction of certain elements in Step 2a.

FIG. 5 is a graphic depiction of certain elements in Step 3.

FIG. 6 is a graphic depiction of certain elements in Step 4.

FIG. 7 is a graphic depiction of certain elements in Step 5.

FIG. 8 is a graphical demonstration of the Trust Seal parameters.

### DETAILED DESCRIPTION OF THE EMBODIMENTS

### 1. Introduction

The proposed trust seal has dimensionality, possibly presented as a spider web diagram with 7±2 edges, so people can easily assess it, and dynamically assess the output of an LLM with related corpora. Thus, for example, when evaluating financial reports, the dynamically created spider web diagram may contain 6 sides anchored at truthfulness (e.g., accuracy, relevance, political bias, certainty, source reliability in the past) and comparison to other corresponding companies in the industry. Regarding other content, there may be additional relevant dimensions. On each of those dimensions, a document may be assessed, for example, on a scale of 1 to 7 (the scale size may be determined as part of this proposal by testing with actual users of the information). The trust seal may be attached to the LLM-generated report as a scorecard. We envision that, as a human user interacts with and questions the LLM, they may be able to prompt it more effectively based on the identified trust-seal problems at each iteration.

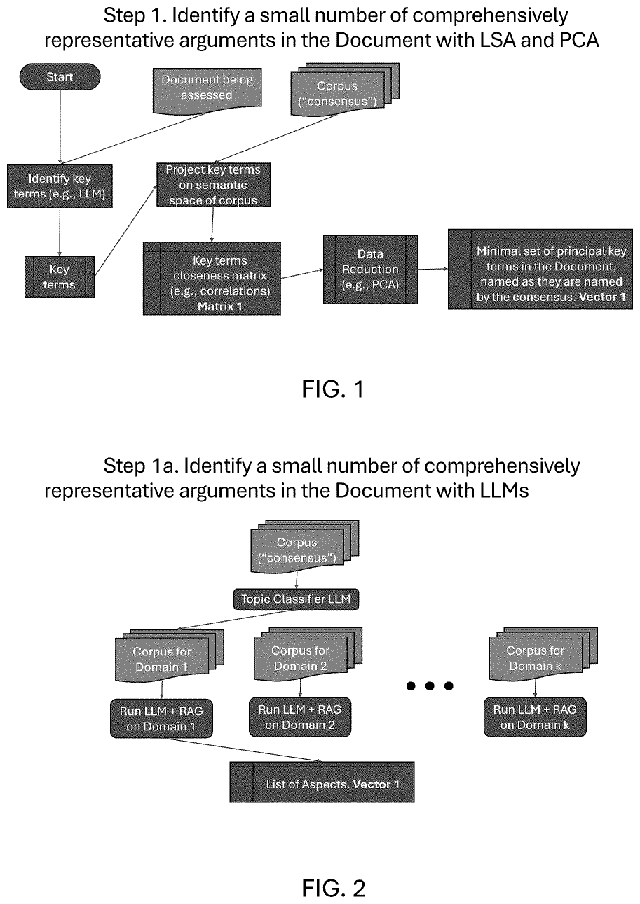

A demonstration of what the seal may look like is shown in FIG. 1.1. Other dimensions may be added in the case of each particular document. Building on the LLM-as-a-judge perspective, the trustworthiness dimensions shown on the trust seal may be dynamically generated by combining recommendations from a set of existing LLMs. Each of those LLMs may be prompted to actualize existing definitions of human trustworthiness and IT trustworthiness as they apply to a corpus of equivalent documents. The seal presents the numeric average assessment for each dimension across the corpora and the particular document being assessed. Depending on ergonomic assessments of the prototype, the seal may include additional features, such as a 95% confidence interval around each value in the figure, and may apply existing statistical methods for inter-rater reliability, such as Kappa. The seal may also provide the reasons for each dimension of the trust seal so that users can verify its veracity.

This ability to objectively measure multiple dimensions of trustworthiness could be a valuable first step towards assessing LLM bias, divisiveness, harmfulness, and even subversion and institutionalized bias across many contexts. It could be an initial solution to the problem. Juvenal, the Roman poet, questioned, “Quis custodiet ipsos custodes?” (Who guards the guards?). It may also advise authorities on how to include safeguards in LLM-generated content.

The quality and accuracy of the trust seal may be evaluated by human subjects asked to assess artificially generated LLM content. The LLM creating that content may be prompted to make that content biased along a set of dimensions previously created by another LLM based on corpora of the same context.

### Contributions

The proliferation of unregulated and regulated online AI-generated content necessitates an automated method to assess its trustworthiness. The fact that the actual, detailed meaning of trustworthiness is document-specific and context-dependent underscores the need for an automated AI tool that can account for this dynamic nature. That is, the current definition of trustworthiness, which broadens assessments of ability, benevolence, and integrity, may take into account the context of those assessments, such as the kinds of ability involved. That same argument applies to the suggested alternative definition of trustworthiness, as it might apply to an IT system rather than to a human, based on its helpfulness, reliability, and functionality, since the actual practical meaning of helpfulness, reliability, and functionality depends on the content of the assessed document. The proposed approach brings together theories, models, and empirical insights from the humanities, social sciences, and computer and information sciences to develop the assessment criteria that can capture the dynamic nature of trustworthiness in the context of AI-generated content.

An advantage of this seal is that it creates an objective, dynamic, numeric method for doing so. The ability to automatically monitor bias might also be a step towards implementing the EU AI Act, specifically its Ethics guidelines for trustworthy AI. Doing so, however, is challenging because in current trust contexts, its meaning is predefined, typically based on assessments of trustworthiness measured in terms of ability, benevolence, and integrity (aka the ABI criteria applied in the social sciences). That definition mostly replicated how Aristotle defined trust in The Rhetoric. That definition has become the accepted one in assessing AI bots'trustworthiness too. The content-generated definition we propose may be more corpora-specific. For example, rather than measuring “ability” or “integrity”, the measure may address many aspects of ability and integrity as they pertain to the specific corpora.

Moreover, trust is largely delegated based on familiarity. That is, a user trusts the content source, e.g., a specific content producer, and, by virtue of that trust, one might trust a specific report too, even regardless of other more objective criteria of trustworthiness. The proposed trust seal overcomes this individual-familiarity bias by using LLMs to dynamically define the trust seal based on the context revealed in the corpora, and then using that LLM-generated evaluation criteria to assess other LLM-generated reports. This process may be informed by the combination of the humanities and social epistemology, the social sciences and trust research, and the computer and information sciences to create the nodes in the trust seal, such as dynamic corpora-specific definitions of “ability” and “integrity.”

### Significance to the Humanities

The issue of the trustworthiness of LLM-generated content is part of understanding wider, digitally driven developments that touch the very heart of contemporary Humanities. Processes of datafication, algorithmization, and platformization permeate all aspects of being and knowing and have created unprecedented opportunities for the production, dissemination, and acquisition of knowledge, with LLMs playing an increasingly dominant role. In principle, these processes can benefit citizens and society, with some envisioning innovative opportunities, such as opinion mining, that could help to create a system fostering mutual understanding. However, these developments raise concerns that require attention. Crucially, data and algorithms can be biased, whether intentionally or not, and algorithms are mostly programmed for commercial ends, potentially creating new inequalities and exacerbating existing ones. As such, they enable and amplify the creation and circulation of potentially harmful, biased, and divisive content, which, together with knowledge silos (filter bubbles, echo chambers), strengthens polarization.

As noted by several authors in the field of (digital) communication, these developments may result in new ways of knowing and may change the very basis of how knowledge is produced, dissemination and acquired, affecting how we know and what we know. Crucially, knowledge and the decisions based on it are increasingly shaped by content mediated by platforms and media, relying on datafication and algorithmization, guided by a neoliberal logic. This is combined with an unparalleled amount and speed of information and with alternative epistemic realities being created. This can undermine trust in traditional foundations of knowledge and knowledge sources and hamper individuals seeking reliable and trustworthy information. While a measure of epistemic anxiety ensures recognition that some fact requires an explanation, systematic uncertainty regarding what you know creates epistemic distress.

Generative AI offers transformative benefits like broadened access to information, yet poses significant challenges to epistemic stability. The ability of LLMs to produce human-like text can blur boundaries, including those between facts and misinformation, and affect how knowledge is created. It also makes it increasingly difficult for individuals to discern credible information and to understand and trust how knowledge is generated and distributed. This epistemic ambiguity is compounded by LLMs'lack of inherent accountability or verifiability, as they create responses based on statistical patterns in data rather than a grounded understanding of truth [20]. Moreover, the proliferation of AI-generated content risks overwhelming traditional mechanisms of fact-checking and critical scrutiny, contributing to a broader erosion of trust in information ecosystems.

Some scholars have identified these trends as an information crisis in which technology-driven threats to truthful information undermine trust in available (sources of) information. Others emphasize that the crisis extends beyond information to a deleterious transformation of the knowledge order, impacting the overarching structure of knowledge, changing processes of knowledge production, the contexts in which knowledge is generated, knowledge hierarchies, and the roles of various agents in knowledge production, dissemination, and acquisition. This has the potential to create an epistemic crisis in which citizens lose their epistemic agency and autonomy. These challenges to knowledge acquisition are feared to coexist and merge with socio-political developments, including populism, autocracy, and the dwindling credibility of scientific institutions.

This comes at a time when the United States is experiencing a decades-long crisis in public trust in public institutions. According to Pew Research Center data, only a quarter of Americans (24%) “trust the federal government to do what is right.” This occurs alongside a declining trust in national, mainstream commercial news media, even less trust in social media as information sources, and eroding trust in science and the institutions that produce and disseminate knowledge. The rise of mis/disinformation, amplified by digital platforms, has created a fragmented information ecosystem where falsehoods spread more quickly than verified facts. The disconnect between the production and distribution of information undermines trust in its truthfulness on the public's end of this knowledge chain. This erosion of trust undermines the social contract between knowledge producers and the public, threatening the epistemic foundations necessary for informed decision-making in democratic societies. As such, dwindling trust is directly related to the epistemic crisis, as captured in Abiri and Buchheim's notion of the epistemic divide, i.e., the fragmentation of society into separate epistemic communities.

A way out of this epistemic crisis requires addressing these challenges in various ways, including embedding ethical safeguards into AI development, promoting digital literacy to empower users, and fostering transparency in how AI-generated information is produced and validated. We argue that it is important to restore confidence in the truthfulness of information and to foster transparency, inclusivity, and accountability in knowledge production. For information and knowledge generated by LLMs, we need to ensure the truthfulness and trustworthiness of the generated content and communicate (through trust seals) that it is epistemically trustworthy. To this end, we innovatively combine insights from trust research, which identifies through the widely accepted definition of trustworthiness as ability, benevolence, and integrity, with those from social epistemology that help to clarify what the ‘ability’ means in the case of epistemic trustworthiness.

To this end, we turn to social epistemologists, especially Alvin Goldman, who identifies a set of truth-linked standards, any or all of which can be used to appraise social institutions and practices: (1) reliability, (2) power, (3) fecundity, (4) speed, and (5) efficiency. These standards can be thought of as evaluative criteria for knowledge creation, gathering, and distribution also through LLMs. From this perspective, the reliability of an LLM is measured by “the ratio of truths to total number of beliefs fostered by the practice;” the power by “its ability to help cognizers find true answers to the questions that interested them;” the fecundity of a structure or practice is “its ability to lead to large numbers of true beliefs for many practitioners;” the speed of a structure's procedure or practice is how quickly it leads to true answers, while the efficiency of a practice is “how well it limits the cost of getting true answers.” When these standards are fulfilled, an LLM can be considered trustworthy in generating truthful knowledge. As such, the epistemic standards provide a starting point for the design of a trust seal for LLM-generated content.

This role of the LLM in creating a dynamic, corpora-specific dimensionality sets it apart from established Better Business Bureau (BBB)1 accreditation and TRUSTe Privacy Certification2-type seals that apply to a company and create initial trust mostly among new buyers of small online retailers for high-value purchases.

### 2. Methods—Introduction

Since their public introduction in late 2022, the use cases for LLMs have rapidly expanded from companion chatbots to experts in specialized domains. A general approach to training LLMs for specialized domains is called fine-tuning or few-shot learning, in which an already trained LLM is fed additional training data or examples from the specialization domain to adjust its weights. A new application domain for LLMs is LLM-as-a-judge, in which an LLM is fine-tuned to assess various aspects of generated content (such as quality, factuality, etc.) in a specific domain. Simultaneously, a plethora of recent work has focused on designing benchmarks to evaluate the performance of LLMs and judges in various new domains (see e.g., Utilizing the LLM as a judge paradigm, we can evaluate each aspect of the seal, aspects that may be decided depending on the context but that can include correctness, bias, etc. using either proprietary or open-sourced LLMs. For prosperity models, we can test the effectiveness of different prompting techniques in generating the correct values for the aspects in the seal. For open-sourced models, we either fine-tune a pre-trained language model on labeled data or apply existing approaches designed for specific quantities, such as factuality. To collect labeled data, we can generate posts from different language models and, depending on the amount of label data required, either manually label them ourselves or use crowdsourcing platforms such as Amazon Mechanical Turk or Prolific.

A challenge to address arises from possible conflicts in the answers provided by different LLMs. Therefore, we consider an aggregation scheme to combine the answers provided by different LLMs. A simple baseline can be majority voting (for binary yes/no answers) or averaging (for numerical answers). However, different LLMs might have various levels of confidence/uncertainty in their provided answers [39]. We plan to use these confidence levels by designing weighted aggregated schemes that assign weight proportional to the confidence of the LLM.

To generate the trust seal, the method may use the broadly accepted social science definition of trustworthiness, such as ability, benevolence, and integrity, and combine it with insights from social epistemology on truthfulness, and apply an LLM to identify these definitions, based on a broad corpus of text. Further additions to the seal may include expanded definitions by adding terms/words related to ability, benevolence, and integrity within that corpus, based on Latent Semantic Analysis (LSA), Latent Dirichlet Allocation (LDA), Word2Vec, GloVe, and Transformer-based models such as BERT or the GPT family of models. Additional features may include training a neural network model to identify these terms dynamically based on the generated content.

In an aspect, the methods described herein may be implemented by a computer system comprising one or more processors, system memory, and one or more non-transitory storage devices. The system memory stores executable instructions that, when executed by one or more processors, cause the processors to retrieve documents and corpora from local or remote data stores, construct and store semantic matrices and vectors, execute statistical and language-model-based analyses, and generate trustworthiness outputs. Intermediate data structures, including vectors, matrices, confidence measures, and aggregation weights, are stored in memory during execution and may be persisted for subsequent processing or auditing.

### 3. System and Method Steps

These are the steps the system and method may take:
Step 1. Identify a small number of the most-important “truth” arguments (keywords) in the assessed Document using known-in-the-art tools.

a. The objective of this step is to produce a small but representative vector of the keywords in the Document. This is done by extracting the keywords in the document using known-in-the-art methods such as latent semantic analysis (LSA) (see, for example, U.S. Pat. No. 4,839,853, herein incorporated by reference as if fully set forth herein) and then reducing that list using known-in-the-art data reduction methods such as principal components analysis (PCA). As an integral part of such data reduction methods, only those principal components (known as “factors” in other data reduction methods such as exploratory factor analysis (EFA)) that contribute the most to the explained covariance among the keywords are retained. Those principal components may be identified, for example in a PCA, as those principal components that have an eigenvalue of 1 and above. Each principal component/factor may be named the same as the most highly loading keyword in that principal component/factor. In that aspect, the list of principal components/factors may be limited to 5-9 keywords to make it more manageable.

b. In an aspect, this process can be achieved through a combination of LSA and PCA analyses, see FIG. 1.

i. Retrieve Document

ii. Identify key terms in the document, for example, by LSA to identify key words (terms) in the document,

iii. Project those terms on a semantic space of a related corpus or corpora to create a matrix, Matrix 1, of semantic closeness (e.g., correlations or cosine distances) among each pair of such terms in that semantic space, where the semantic space is used as a “reference” of the “consensus” among “experts”. This can be done through a variety of known-in-the-art tools such as LSA.

iv. Run a known-in-the-art data reduction process (e.g., PCA) on Matrix 1. The output of that data reduction is a minimal set of principal key terms in the Document, named as the consensus names them. This produces Vector 1.

1. In an aspect, the threshold number of principal components may be derived as the default of that method as commonly used. (In the case of a PCA that can be an eigenvalue of 1 and above.)

2. In another aspect, any other threshold can be input into the system.

3. In yet another aspect, the threshold can be derived dynamically so it best fits the data through any of the known-in-the-arts methods that do so such as a Scree-test.

v. The principal components matrix may be rotated (e.g., using varimax or any other known-in-art method) to make identifying the name of the principal component easier.

1. Terms loading above a predefined known-in-art threshold in that rotated matrix (e.g., .60 if a PCA is used) may be treated as belonging to that principal component.
a. In an aspect, any other threshold-determining method can be used, including an external parameter provided to the system.

2. The name of the highest loading term in each of the data reduction output vector 1 may be the name of that “argument”, i.e., principal component/factor.

3. Notice that as a consequence of running such data reduction methods, items (terms) that load low may be dropped from the analysis. This is important because only the key components, identified as those that correlate highly with other components, are retained.

c. In another aspect, this process can be achieved through a combination of LLMs and RAGs, refer to FIG. 2.

i. Retrieve Document

ii. Identify document topics using a pre-trained LLM. This pretraining is being done on an equivalent corpus of documents.

Iii. Then, for each topic domain identified (shown as 1, 2, . . . k) in the previous step, run an LLM with Retrieval-Augmented Generation (RAG) to create a set of aspects that relate to each document topic. These sets of topics are accumulated into Vector 1.
Step 2. Assessing omitted and extra dimensions of most important “truth” arguments (keywords) in the assessed Document compared to the corpus

a. The objective of this step is to compare the vector of small but representative keywords in the Document as produced in step 1 to an equivalent vector of related keywords in the corpus. The corpus-derived vector represents the apparent “consensus” among related documents of all keywords that relate to those produced in step 1. It is expected that, because of the data reduction process, keywords of lesser weight may be excluded from either or both vectors. Comparing the two vectors may identify: (1) keywords that appear in both vectors, (2) keywords that are missing in the Document but appear in the corpus (representing “arguments” that are either ignored or given low weight in the document being assessed and so are excluded), and (3) keywords that appear only in the Document (representing minority report “arguments”) that are outside the apparent “consensus” as it can be derived from a related corpus or corpora.

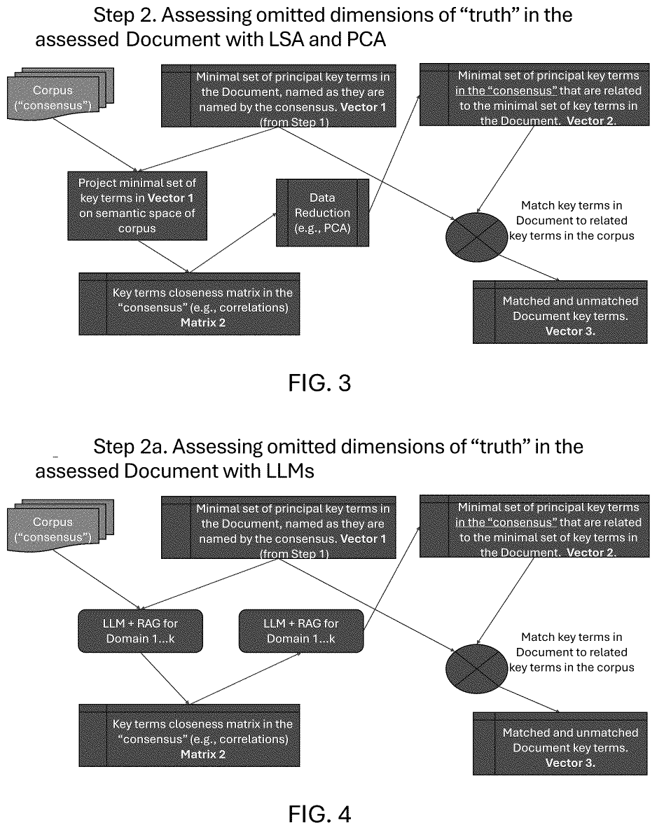

b. In an aspect, this process can be achieved through a combination of LSA and PCA analyses, refer to FIG. 3.

i. Project the minimal set of principal key terms in the Document, named as the consensus names them, Vector 1 (from Step 1), on a semantic space derived from a related corpus or corpora.

ii. The results of that projection may be a key terms closeness matrix in the “consensus” (e.g., correlations) of terms in the consensus that are related to the terms in the Document. This may create Matrix 2.

iii. Running a data reduction method, such as but not limited to PCA, may produce a new matrix of a minimal set of principal key terms in the “consensus” that are related to the minimal set of key terms in the Document. This is Vector 2.

iv. In an aspect,

1. The number of principal components may be derived as the default of that method as commonly used. (In the case of a PCA that can be an eigenvalue of 1 and above.)

2. In an aspect, any other threshold can be input into the system.

3. In yet another aspect, the threshold can be derived dynamically so it best fits the data through any of the known-in-the-arts methods that do so such as a Scree-test.

v. The principal components matrix may be rotated (e.g., using varimax or any other known-in-art method) to make identifying the name of the principal component easier.

vi. Terms loading above a predefined known-in-art threshold in that rotated matrix (e.g., .60 if a PCA is used) may be treated as belonging to that principal component.

1. In an aspect, any other threshold-determining method can be used, including an external parameter provided to the system.

vii. Matching key terms in Vector 1 and Vector 2 may then produce a vector of matched and unmatched Document key terms. That is Vector 3.

c. In another aspect, this process can be achieved through LLMs, refer to FIG. 4.

i. Rather than run an LSA to project the terms of Vector 1 on the Corpus to create Matrix 2, run LLM+RAG, and, rather than run a PCA to identify the key related terms in the corpus to create Vector 2, run LLM+RAG to create Vector 3, as shown in FIG. 2.
Step 3. Assess the strength of those “truth” arguments in the Document as they relate to the “consensus” among “experts”, i.e., in the corpus.

a. The objective of this step is to assign a measure of “truth” to each of the retained key terms identified in the Document. This measure is a measure of how well each specific key term is predicted in the corpus by the other key terms in the Document vector of terms (the matched section of Vector 3). This can be calculated, for example, using correlation, cosine distance, or any other known-in-the-art fit index.

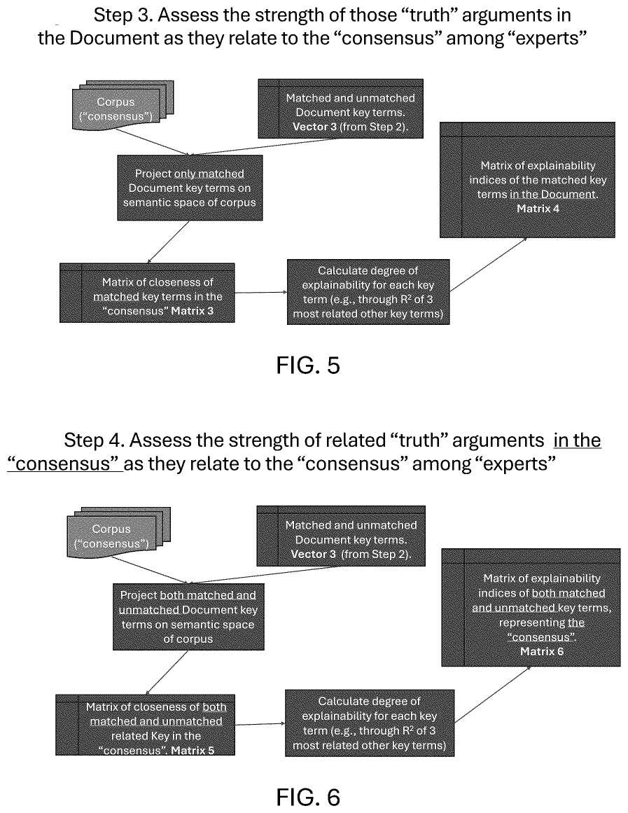

b. In an aspect, this process can be achieved through a combination of LSA and PCA analyses, refer to FIG. 5.

i. The matched and unmatched Document key terms in Vector 3 (from Step 2) are projected on the corpus or corpora to produce a matrix of closeness in the corpus of matched key terms (i.e., those that appear in both the Document and the corpus), creating Matrix 3. That measure of closeness can be any known-in-the-art fit index, such as but not limited to correlation, cosine distance, R², _{adj}R², F statistic, Chi-squared measure of fit, NFI (Bentler Bonnet Index of Normed Fit Index), CFI (Comparative Fit Index), RMSEA (Root Mean Square Error of Approximation), AIC, BIC, and/or any other known-in-the-art method of assessing models.

ii. Based on Matrix 3, the method then calculates a degree of explainability for each key term (e.g., running a linear regression of each term on the 3 most related other key terms to produce an R² statistic), creating a new matrix of explainability indices of the matched key terms in the Document, Matrix 4.

1. In an aspect, the process can be run on all or any other determined number of keywords (e.g., as set through user input).

2. In another aspect, rather than take the 3 most related other terms, any other upper limit can be set up to n-1, where n is the total number of principal components extracted.
4. Step 4. Assess the strength of related “truth” arguments in the “consensus”. This step parallels Step 3, except that it projects both matched and unmatched Document key terms onto the corpus's semantic space, rather than projecting only the matched terms.

a. The objective of this step is to assign a measure of “truth” to each of the key terms in the corpus that corresponds to the key terms identified in the Document. This index is a measure of how well each specific key term is predicted by the other key terms in the corpus (Step 3 was about predicting based only on the key terms in the Document). This may be done, for example, through correlation, cosine distances, or any other known-in-the-art fit index. This may allow for a comparison of how well each key term in the Document is predicted/related-to the other key terms when assessed based only on the key terms in the Document as done in step 3 (representing key arguments in the Document itself alone) versus when it is predicted/related-to the other key terms that appear in the corpus too as related to those key terms in the Document as done in this step (representing key arguments that may have been left out in the Document itself but appear in connection to those key terms in the consensus as it is reflected in the corpus, or, likewise, key arguments that appear in the Document but not in the corpus).

b. In an aspect, this process can be achieved through known-in-the-art statistical methods, refer to FIG. 6.

i. Both the matched and the unmatched Document key terms in Vector 3 (from Step 2) are projected on the corpus or corpora to produce a matrix of closeness of both matched and unmatched key terms in the “consensus”, creating Matrix 5. That measure of closeness can be any known-in-the-art fit index, such as but not limited to correlation, cosine distance, R², _{adj}R², F statistic, Chi-squared measure of fit, NFI (Bentler Bonnet Index of Normed Fit Index), CFI (Comparative Fit Index), RMSEA (Root Mean Square Error of Approximation), AIC, BIC, and/or any other known-in-the-art method of assessing models.

Ii. Based on Matrix 5, the method then calculates a degree of explainability for each key term (e.g., running a linear regression of each term on the 3 most related other key terms to produce an R² statistic), creating a new matrix of explainability indices of both matched and unmatched key terms, representing the “consensus”, Matrix 6.

1. In an aspect, the process can be run on all or any other determined number of keywords (e.g., as set through user input).

2. In another aspect, rather than take the 3 most related other terms, any other upper limit can be set up to n-1, where n is the total number of principal components extracted.
Step 5. Display “Truth” Report.

a. The objective of this step is to compare the explainability of each key term in the Document as it is predicted by the matched key terms in the Document, Matrix 4, versus when it is predicted by both matched and unmatched key terms, representing the “consensus,” Matrix 6.

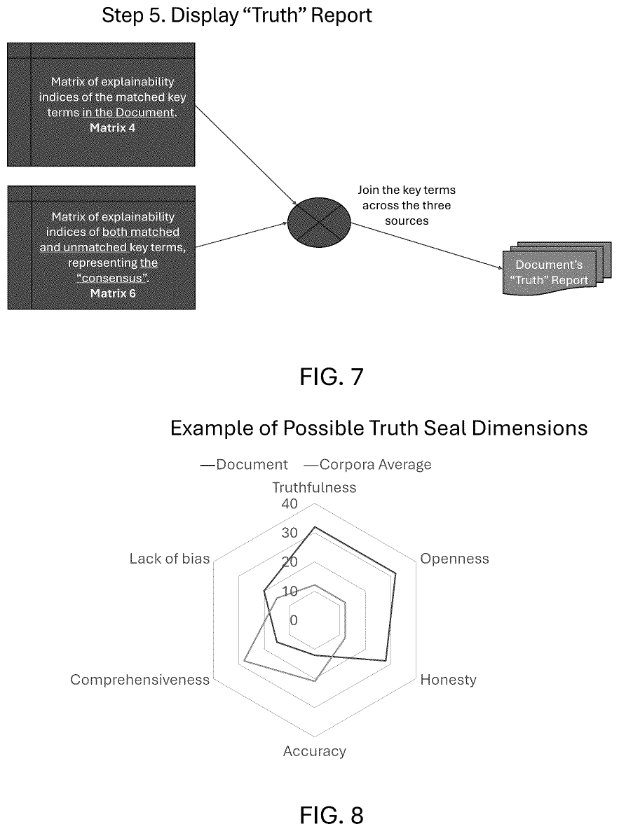

b. In an aspect, this process can be achieved through known-in-the-art methods, refer to FIG. 7.

Run a join, for example, as a SQL Outer Join operation, of Matrix 4 and Matrix 6. The result may show the explainability of each of the key terms in the Document and those key terms not in the Document but related to those key terms in the corpus, as two numbers for each key term.

### Trust Seal Data Structure

In an aspect, the trust seal is generated as a structured data object comprising a plurality of fields corresponding to trustworthiness dimensions, each field storing a quantitative score, optional confidence interval, and metadata identifying whether the associated dimension is matched, omitted, or additional relative to the corpus. The trust seal data object may be stored in a machine-readable format and accessed by other software components to control content regeneration, filtering, ranking, or presentation, independent of any particular graphical visualization.

### Representation

In an aspect, the results can be shown graphically (e.g., as a cobweb presentation).

In another aspect color coding can be added so that different colors are assigned to each key term based on whether it appears in both the Document and the corpus (e.g., green), only in the Document (e.g., yellow) in which case it might indicate a minority opinion argument that needs attention, or only in the corpus (e.g., red) in which case it might indicate a missed argument that needs more attention.

The results may be displayed graphically as shown in FIG. 8, Possible Truth Seal Dimensions.

### Technical Improvements Over Prior Systems

The systems and methods described herein provide concrete technical improvements to computer-implemented systems for evaluating AI-generated content. Where conventional approaches rely on static rules and/or post-hoc human review, the disclosed system and methods generate trustworthiness dimensions derived from reference corpora and apply large language models as automated evaluators.

Configuring multiple LLMs to operate as machine-executed judges that assess generated content across distinct the trust seal dimensions produces a valuable output. The system aggregates these outputs automatically using weighted schemes, producing a multidimensional trust representation. This aggregation process improves robustness and reduces the sensitivity of content evaluation.

The disclosed systems may further improve computer functionality by enabling iterative feedback loops between the trust seal generation and the content generation process. Trust seal outputs may be used to guide generation of LLM-generated content, thereby improving the computational model. This feedback mechanism allows computer systems to converge toward content that satisfies context-specific trust criteria without the need to retrain underlying language models.

The trust seal outputs may also be used as control inputs to a content-generation pipeline. Based on one or more trustworthiness dimensions failing to satisfy predefined criteria, the system may automatically modify prompts, retrieval parameters, or model selection for subsequent language-model executions. This feedback mechanism alters the operational behavior of the computer system by guiding future content generation, improving computational reliability and reducing propagation of biased/unsupported outputs without retraining the underlying language models.

While the invention has been described with reference to the embodiments above, a person of ordinary skill in the art would understand that various changes or modifications may be made thereto without departing from the scope of the claims.

We claim:

1. A computer-implemented method for dynamically verifying trustworthiness of AI-generated content, comprising:
receiving, by one or more processors, a document generated by a language model;
extracting, using one or more statistical or language-model-based techniques, a reduced vector of principal terms representing key truth-related arguments of the document;
comparing the reduced vector to a corpus-derived vector representing consensus terms from related documents; computing quantitative explainability metrics for the principal terms based on relationships within the corpus; and
generating a multidimensional trust representation indicative of trustworthiness of the document.

2. The method of claim 1, wherein extracting the reduced vector comprises applying latent semantic analysis followed by a data reduction technique.

3. The method of claim 2, wherein the data reduction technique comprises principal component analysis with a threshold criterion.

4. The method of claim 1, wherein extracting the reduced vector comprises prompting a language model trained on a related corpus to identify representative topics.

5. The method of claim 1, wherein comparing the reduced vector to the corpus-derived vector identifies matched, omitted, and additional principal terms.

6. The method of claim 1, wherein computing quantitative explainability metrics comprises calculating correlation or cosine-distance measures.

7. The method of claim 6, wherein the explainability metrics include regression-based goodness-of-fit values.

8. The method of claim 1, wherein generating the multidimensional trust representation comprises aggregating metrics across multiple trust dimensions.

9. The method of claim 8, wherein the trust dimensions are dynamically derived from the corpus.

10. The method of claim 1, further comprising iteratively updating content generation prompts based on the multidimensional trust representation.

11. A system for dynamically verifying trustworthiness of AI-generated content, comprising:
at least one processor; and
a non-transitory computer-readable medium storing instructions that, when executed, cause the processor to perform the method of claim 1.

12. The system of claim 11, wherein the instructions configure multiple language models to independently evaluate trustworthiness dimensions.

13. The system of claim 12, wherein outputs of the multiple language models are aggregated using confidence-weighted averaging.

14. The system of claim 11, wherein the trust representation is rendered as a graphical multidimensional score.

15. The system of claim 14, wherein the graphical score includes visual indicators corresponding to omitted or minority arguments.

16. The system of claim 11, wherein the corpus comprises documents within a predefined topical domain.

17. The system of claim 11, wherein the trust representation includes statistical confidence intervals.

18. The system of claim 11, wherein the system is configured to operate without retraining an underlying language model.

19. A non-transitory computer-readable medium storing instructions that, when executed by a processor, cause the processor to perform the method of claim 1.

20. The computer-readable medium of claim 19, wherein the instructions further cause iterative refinement of generated content based on trust metrics.
